(19) United States
(12) Patent Application Publication
(10) Pub. No.: US 2006/0016475 A1
(43) Pub. Date: Jan. 26, 2006

(54) Refrigerant relief device

(75) Inventor: Hisatoshi Hirota, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TGK CO., LTD., Tokyo (JP)

(21) Appl. No.: 11/186,809

(22) Filed: Jul. 22, 2005

(30) Foreign Application Priority Data
Jul. 26, 2004 (JP) 2004-216757

(51) Int. Cl. F16K 17/16

(52) U.S. Cl. 137/68.29

(57) ABSTRACT

To provide a refrigerant relief device capable of operating reliably by a simple construction without causing leakage of refrigerant. A refrigerant-introducing chamber defined in a body that forms a joint for connection to piping of a refrigeration cycle, and an open-to-atmosphere chamber communicating with the atmosphere via openings are isolated by a metal thin film from each other, and the metal thin film is welded to the body to prevent leakage of refrigerant. The metal thin film receiving refrigerant pressure is held by a belleville spring. When the refrigerant pressure becomes higher than a set pressure, the belleville spring is inverted in shape to displace the metal thin film toward the open-to-atmosphere chamber. A piercing rod is disposed at a location where the metal thin film is displaced. The piercing rod breaks the metal thin film, and releases refrigerant in the refrigeration cycle into the atmosphere to thereby suddenly decrease the refrigerant pressure.

### CROSS-REFERENCES TO RELATED APPLICATIONS, IF ANY

This application claims priority of Japanese Application No. 2004-216757 filed on Jul. 26, 2004 and entitled “REFRIGERANT RELIEF DEVICE”.

### BACKGROUND OF THE INVENTION

(1) Field of the Invention

The present invention relates to a refrigerant relief device, and more particularly to a refrigerant relief device which is mounted in a refrigeration cycle for an automotive air conditioner such that it can protect the refrigeration cycle from abnormally high pressure of refrigerant in the refrigeration cycle.

(2) Description of the Related Art

A typical automotive air conditioner comprises a compressor for compressing refrigerant circulating through a refrigeration cycle, a condenser for condensing the compressed refrigerant, a receiver/dryer for separating the condensed refrigerant into a gas and a liquid while temporarily storing the refrigerant circulating through the refrigeration cycle, an expansion device for throttling and expanding liquid refrigerant obtained by gas/liquid separation, and an evaporator for evaporating the expanded refrigerant and returning the same to the compressor.

Now, since the compressor compresses refrigerant and discharges the compressed refrigerant, a line from a discharge chamber of the compressor to the expansion device is placed in a high-pressure state. Pressure in this high pressure line sometimes becomes abnormally high e.g. when the amount of charged refrigerant is large, or when the compressor is operating with the maximum capacity due to high cooling load. The abnormally high pressure in the high pressure line can lead to rupture of the condenser or the receiver/dryer, and hence places the air conditioner in a very dangerous state. To solve this problem, a pressure sensor is provided on the discharge side of the compressor to always monitor a state of pressure in the high pressure line. When the pressure sensor detects abnormally high pressure, control operation, such as stoppage of operation of the compressor, is performed so as to prevent rupture of components in the high pressure line.

Further, a relief valve is also known which is mounted in the compressor to prevent discharge pressure from becoming equal to or higher than a predetermined value (see e.g. Japanese Unexamined Patent Publication (Kokai) No. 2002-257047). This relief valve is configured such that a valve element thereof is urged in the valve-closing direction by a spring while the valve element is urged against this in the valve-opening direction by pressure from the discharge chamber. When the discharge pressure of the compressor becomes so high as to cause the urging force of the discharge pressure in the valve-opening direction to exceed the urging force of the spring in the valve-closing direction, the relief valve permits the discharge pressure to escape to the atmosphere to thereby lower the increased discharge pressure. When the discharge pressure is made lower than the predetermined value, the relief valve is closed to return to its original normal state.

Furthermore, a relief device is also known which releases refrigerant in the refrigeration cycle to the outside though it is not an object thereof to prevent breakage of components by the abnormally high pressure in the refrigeration cycle (see e.g. Mahmoud Ghodbane, Ph.D., James A. Baker, William R. Hill, and Stephen O. Andersen, Ph.D., ‘R-152a Mobile A/C with Directed Relief Safety System’, pages 4 and 13. [online]. SAE(The Society of Automotive Engineers), 2003 Alternate Refrigerants Systems Symposium presentations Aug. 1, 2003. [retrieved on 2004-03-12]. Retrieved from the Internet: <URL:http://www.sae.org/altrefrigerant/presentations/presw-hill.pdf>). The relief valve is provided in a refrigeration cycle for an automotive air conditioner using e.g. carbon dioxide or HFC-152a, which can have serious adverse influence on occupants, as refrigerant, and when an accident occurs in which, e.g. a component of the refrigeration cycle is seriously damaged e.g. by aging or a collision accident, to cause emission of a large amount of refrigerant into the vehicle compartment, the relief device releases the refrigerant in the refrigeration cycle to the outside of the compartment. The relief device is thus configured to eliminate a risk that occupants are suffocated by carbon dioxide emitted into the vehicle compartment, or a risk of occurrence of a fire by inflammable HFC-152a catching fire.

When the pressure in the high pressure line becomes abnormally high, if the refrigerant in the refrigeration cycle is intended to be released into the atmosphere, it is possible to employ the relief valve or the relief device described above. However, the relief valve suffers from the problem that refrigerant may internally leak at a valve portion thereof in normal use, and the relief device suffers from the problem that it may not operate when an electric system thereof is faulty under abnormally high pressure of refrigerant, since it is presumed that the relief device has a complicated configuration for operating in a manner interlocked with detection of a collision by the collision sensor though its specific configuration is not shown.

### SUMMARY OF THE INVENTION

The present invention has been made in view of these problems, and an object thereof is to provide a refrigerant relief device which is capable of operating reliably by a simple construction without causing leakage of refrigerant.

To solve the above problem, the present invention provides a refrigerant relief device for releasing refrigerant filled in a refrigeration cycle for an automotive air conditioner into the atmosphere when pressure of the refrigerant in the refrigeration cycle has become abnormally high, comprising a thin film that is disposed in a manner gastightly isolating a first chamber connected to the refrigeration cycle for having the pressure of the refrigerant introduced therein and a second chamber communicating with the atmosphere from each other, a thin film-holder disposed in the second chamber, for holding an amount of displacement of the thin film up to a predetermined value against the pressure of the refrigerant in the refrigeration cycle until the pressure of the refrigerant reaches a set pressure, and a thin film-breaking section that is operable when the pressure of the refrigerant in the refrigeration cycle becomes higher than the set pressure to thereby cause the amount of displacement of the thin film to exceed the predetermined value, to break the thin film to thereby release the refrigerant in the refrigeration cycle into the atmosphere.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a central cross-sectional view of a refrigerant relief device according to a first embodiment of the present invention.

FIG. 2 is a central cross-sectional view of the refrigerant relief device according to the first embodiment, in a state in which abnormally high pressure is detected.

FIG. 3 is a central cross-sectional view of the refrigerant relief device according to the first embodiment, in a state after the detection of abnormally high pressure.

FIG. 4 is a bottom view of the refrigerant relief device according to the first embodiment.

FIGS. 5A to 5E are diagrams showing examples of the shape of a tip of a piercing rod, wherein FIG. 5A is a front view of the piercing rod, and FIGS. 5B to 5E are bottom views showing four types of shapes of the tip of the piercing rod.

FIG. 6 is a central cross-sectional view of a refrigerant relief device according to a second embodiment of the present invention, in a normal pressure state.

FIG. 7 is a central cross-sectional view of the refrigerant relief device according to the second embodiment, in a state in which abnormally high pressure is detected.

FIG. 8 is a central cross-sectional view of the refrigerant relief device according to the second embodiment, in a state after the detection of abnormally high pressure.

FIGS. 9A and 9B are diagrams showing general views of a refrigerant relief device according to a third embodiment of the present invention, wherein FIG. 9A is a plan view of the refrigerant relief device, and FIG. 9B is a right side view of the refrigerant relief device.

FIG. 10 is a central cross-sectional view of the refrigerant relief device according to the third embodiment, in a normal pressure state.

FIG. 11 is a central cross-sectional view of the refrigerant relief device according to the third embodiment, in a state in which abnormally high pressure is detected.

FIG. 12 is a central cross-sectional view of the refrigerant relief device according to the third embodiment, in a state after the detection of abnormally high pressure.

FIG. 13 is a central cross-sectional view of the refrigerant relief device according to the third embodiment, in a state during energization.

FIG. 14 is a central cross-sectional view of the refrigerant relief device according to the third embodiment, in a state after breakage of a metal thin film.

FIG. 15 is a central cross-sectional view of a refrigerant relief device according to a fourth embodiment of the present invention, in a normal pressure state.

FIG. 16 is a central cross-sectional view of a refrigerant relief device according to a fifth embodiment of the present invention, in a state in which no pressure of refrigerant is applied thereto.

### DESCRIPTION OF THE PREFERRED EMBODIMENTS

Hereinafter, embodiments of the present invention will be described in detail with reference to the drawings.

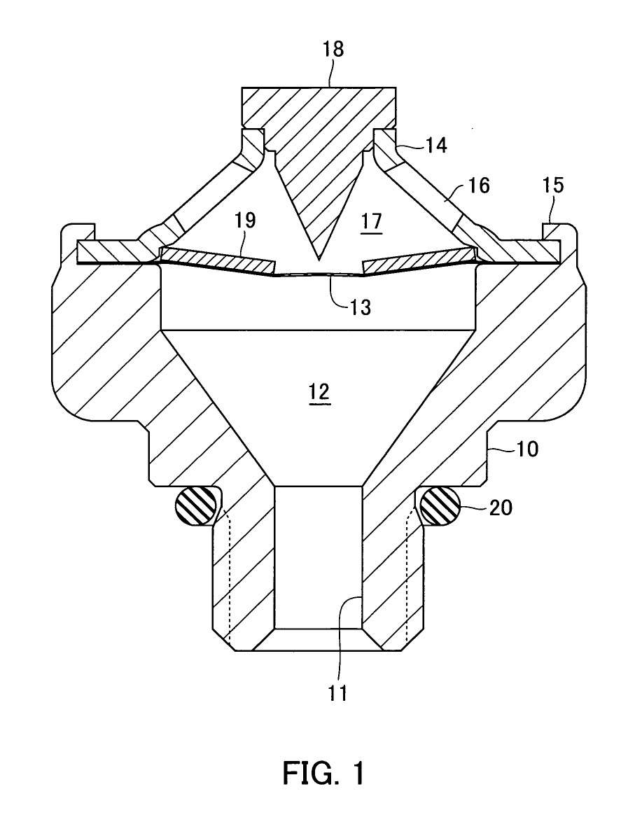

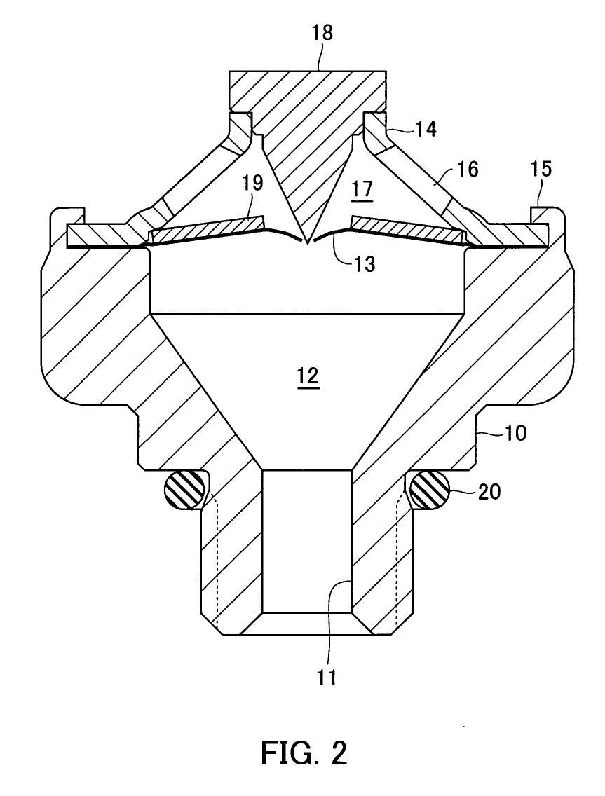

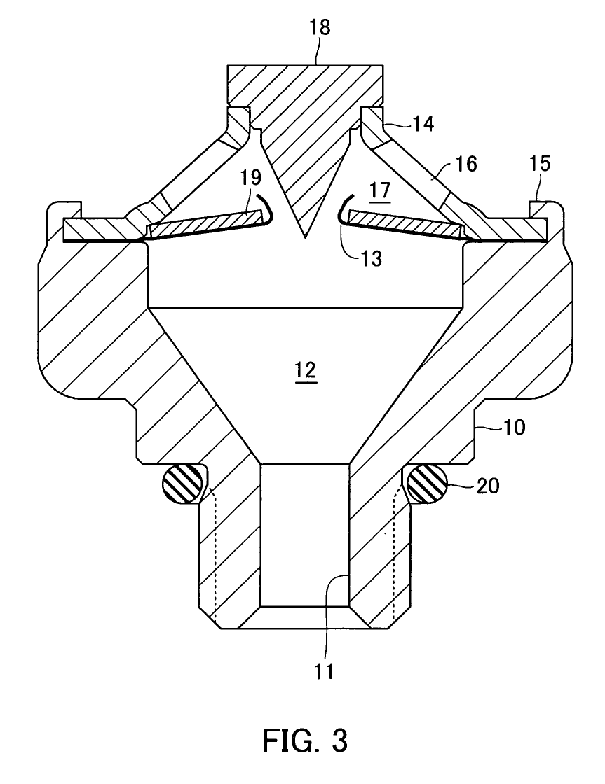

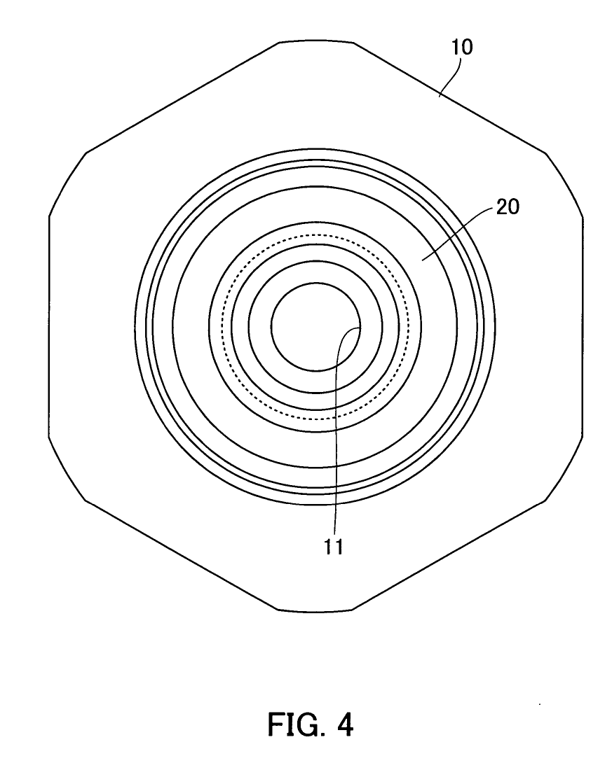

FIG. 1 is a central cross-sectional view of a refrigerant relief device according to a first embodiment of the present invention. FIG. 2 is a central cross-sectional view of the refrigerant relief device according to the first embodiment, in a state in which abnormally high pressure is detected. FIG. 3 is a central cross-sectional view of the refrigerant relief device according to the first embodiment, in a state after the detection of abnormally high pressure. FIG. 4 is a bottom view of the refrigerant relief device according to the first embodiment.

The refrigerant relief device includes a body 10 which has a refrigerant-introducing passage 11 and a refrigerant-introducing chamber 12 formed therethrough in the direction of a central axis thereof. A hollow cylindrical portion of the body 10, which defines the refrigerant-introducing passage 11 therein, forms a joint for connection to piping of a refrigeration cycle, and an outer periphery of the hollow cylindrical portion is formed with a screw.

The body 10 has a metal thin film 13 disposed on an upper surface thereof, as viewed in FIG. 1, in a manner brought into intimate contact with the upper surface such that the metal thin film 13 closes the refrigerant-introducing chamber 12. It is preferred that the metal thin film 13 is welded to the upper surface of the body 10 outside the refrigerant-introducing chamber 12 e.g. by laser welding, whereby the metal thin film 13 is gastightly sealed to the body 10 along the whole circumference thereof.

Disposed above the body 10, as viewed in FIG. 1, is a housing 14 in a manner sandwiching the metal thin film 13 between the same and the body 10. The housing 14 has an outer periphery thereof rigidly fixed to the body 10 by inwardly swaging a hollow cylindrical portion 15 integrally formed with the body 10. The housing 14 has a plurality of openings 16 formed therethrough, and defines an open-to-atmosphere chamber 17, together with the metal thin film 13.

Further, the housing 14 has a piercing rod 18 rigidly fixed to the center thereof, for breaking the metal thin film 13. This piercing rod 18 forms a thin film-breaking section, and is configured such that a tip thereof opposed to the metal thin film 13 has a pointed shape. Furthermore, disposed in the open-to-atmosphere chamber 17 is a belleville spring 19, as thin film-holder, for holding the metal thin film 13 so as to restrict the amount of displacement of the film 13 within a predetermined value against pressure of refrigerant before the pressure of refrigerant reaches a set pressure. The belleville spring 19 is a disc spring having a frustoconical shape and configured such that a hole extends through the center thereof, with a central portion thereof being disposed in a manner protruding toward the refrigerant-introducing chamber 12, and an outer periphery thereof being retained by the housing 14. Further, the belleville spring 19 maintains its shape in a state where the metal thin film 13 is brought into intimate contact therewith by the pressure of refrigerant from the refrigerant-introducing passage 11, and when the pressure of refrigerant exceeds the set pressure, the axial positional relationship between the central portion thereof receiving the metal thin film 13 and the outer periphery thereof whose axial motion is restricted by being retained by the housing 14 is inverted.

It should be noted that the body 10 has an O ring 20 fitted on a root portion of the hollow cylindrical portion defining the refrigerant-introducing passage 11, so as to prevent refrigerant from leaking from the root portion after the refrigerant relief device is joined to the piping of the refrigeration cycle by screwing.

In the refrigerant relief device constructed as above, when the refrigerant in the refrigeration cycle is at pressure within a normal range, the belleville spring 19 is in the state shown in FIG. 1 in which it holds the metal thin film 13 at a location away from the position of the tip of the piercing rod 18 against the pressure of refrigerant.

When the refrigerant pressure has become abnormal pressure higher than the set pressure, the belleville spring 19 is inverted in shape to be placed in a state shown in FIG. 2. As a result, the central portion of the metal thin film 13 is displaced upward, as viewed in FIG. 2, to a location higher than the position of the tip of the piercing rod 18, so that the metal thin film 13 is pierced and broken by the piercing rod 18.

When the metal thin film 13 is broken, the abnormally high-pressure refrigerant is about to flow instantly from a hole formed in the film 13 by breakage thereof. Therefore, as shown in FIG. 3, the size of the hole formed in the metal thin film 13 is increased by the flowing refrigerant, and refrigerant in the refrigeration cycle is released into the atmosphere through the hole increased in size and the openings 16 formed in the housing 14. This causes the pressure of the abnormally high-pressure refrigerant in the refrigeration cycle to be suddenly decreased, thereby making it possible to prevent components in a high-pressure line from being broken.

The above refrigerant relief device has an advantageous feature in that it is possible to accurately know the set pressure of abnormally high pressure at which the metal thin film 13 can be broken, without breaking the metal thin film 13. More specifically, the set pressure of abnormally high pressure in the refrigerant relief device can be accurately known by attaching the refrigerant relief device without the piercing rod 18 to a pressure-measuring jig, increasing pressure in the refrigerant-introducing chamber 12 until the belleville spring 19 is inverted in shape, and reading the pressure at which the inversion of the shape of the belleville spring 19 occurs. Moreover, the belleville spring 19 can be restored to its original state without damaging the metal thin film 13 if the belleville spring 19 is inverted by applying an external force thereto from a hole in which the piercing rod 18 is mounted. After accurate determination of the set pressure at which the refrigerant relief device operates, as described above, the piercing rod 18 is mounted in the housing 14, which completes the refrigerant relief device.

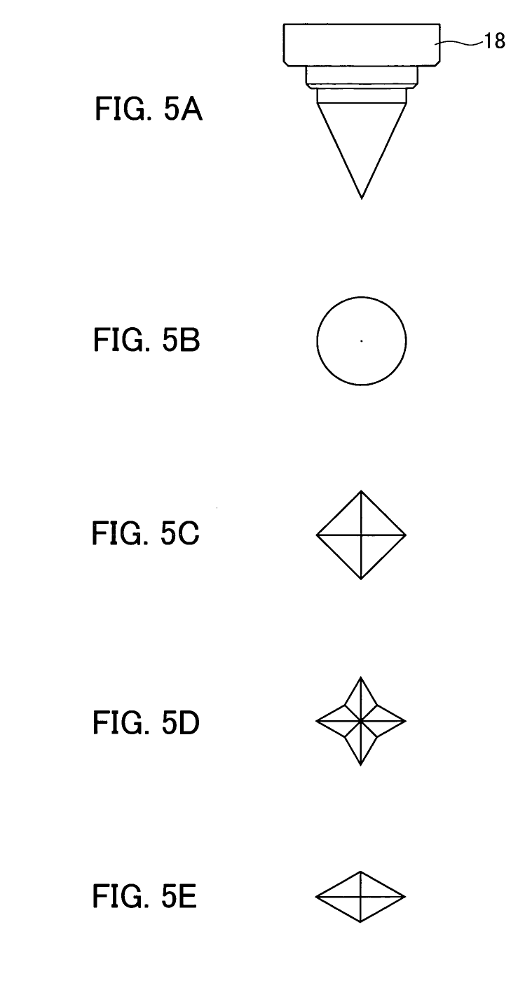

FIGS. 5A to 5E are diagrams showing examples of the shape of the tip of the piercing rod, wherein FIG. 5A is a front view of the piercing rod, and FIGS. 5B to 5E are bottom views showing four types of shapes of the tip of the piercing rod.

The piercing rod 18 has a shape in which the tip opposed to the metal thin film 13 is pointed so as to enable the metal thin film 13 to be easily broken when the film 13 is displaced by abnormally high pressure applied thereto. The tip of the piercing rod 18 opposed to the metal thin film 13 can be configured such that it has a conical shape, as shown in FIGS. 5A and 5B. The tip of the piercing rod 18 can be configured such that it has other shapes, such as a quadrangular pyramid shown in FIG. 5C, a star shape shown in FIG. 5D, and a spear tip-like shape shown in FIG. 5E. Especially, as shown in FIGS. 5B and 5E, if the tip of the piercing rod 18 has portions formed such that they have an acute angle in the circumferential direction, the piercing rod 18 can easily pierce a hole.

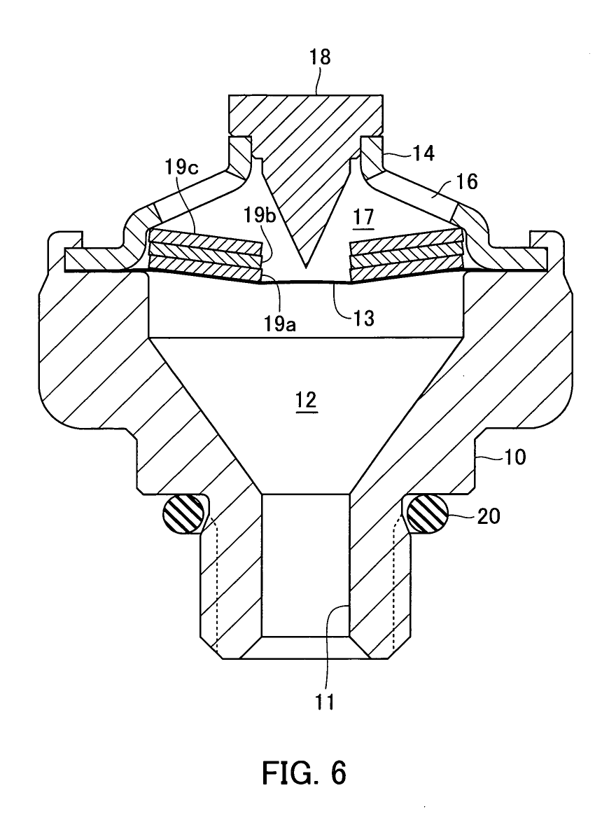

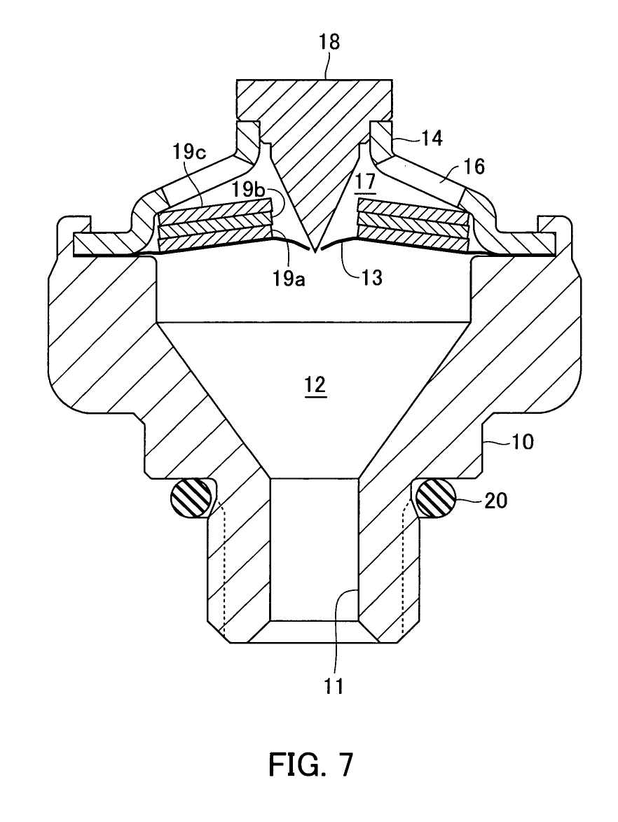

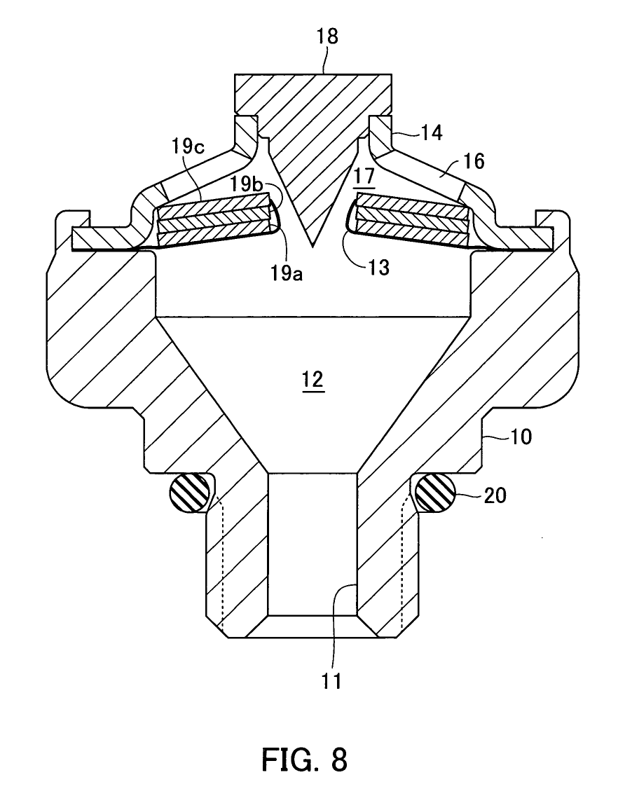

FIG. 6 is a central cross-sectional view of a refrigerant relief device according to a second embodiment of the present invention, in a normal pressure state thereof. FIG. 7 is a central cross-sectional view of the refrigerant relief device according to the second embodiment, in a state where abnormally high pressure is detected. FIG. 8 is a central cross-sectional view of the refrigerant relief device according to the second embodiment, in a state after the detection of abnormally high pressure. It should be noted that component elements in FIGS. 6 to 9 identical to those shown in FIGS. 1 to 3 are designated by identical reference numerals, and detailed description thereof is omitted.

The refrigerant relief device according to the second embodiment is distinguished from the refrigerant relief device according to the first embodiment in that the thin film-holder is formed by three belleville springs 19a, 19b, and 19c overlaid upon each other.

This configuration of the thin film-holder is based on a method employed when load necessary for inversion cannot be obtained by one belleville spring 19. In the present embodiment, load corresponding to a set pressure for sensing abnormally high pressure of refrigerant is realized by using a plurality of belleville springs, i.e. the three belleville springs 19a, 19b, and 19c. A plurality of types of refrigerant relief devices which are different in set pressure can be made by combining the belleville springs 19a, 19b, and 19c which are different in load necessary for inverting the shape thereof. It should be noted that although in the present embodiment, the thin film-holder is implemented by the three belleville springs 19a, 19b, and 19c, this is not limitative, but the thin film-holder may be implemented by a combination of two or more than three disc springs. Further, in this refrigerant relief device as well, the set pressure of refrigerant at which the belleville springs 19a, 19b, and 19c are inverted in shape can be accurately known in advance by a test carried out on the device with no piercing rod 18 mounted therein.

In the refrigerant relief device constructed as above, when refrigerant in the refrigeration cycle is at normal pressure within a normal range, the belleville springs 19a, 19b, and 19c are in a state shown in FIG. 6 in which they hold the metal thin film 13 at a location away from the position of the tip of the piercing rod 18 against the pressure of refrigerant.

When the pressure of refrigerant has become abnormal pressure higher than the set pressure, the belleville springs 19a, 19b, and 19c are inverted in shape to be placed in a state shown in FIG. 7. As a result, since the central portion of the metal thin film 13 is displaced upward, as viewed in FIG. 7, to a location higher than the position of the tip of the piercing rod 18, the metal thin film 13 is pierced and broken by the piercing rod 18.

When the metal thin film 13 is broken, the abnormally high-pressure refrigerant is about to flow instantly from a hole formed in the film 13 by breakage thereof. Therefore, as shown in FIG. 8, the size of the hole formed in the metal thin film 13 is increased by the flowing refrigerant, and refrigerant in the refrigeration cycle is released into the atmosphere through the hole increased in size and the openings 16 formed in the housing 14. This causes the pressure of the abnormally high-pressure refrigerant in the refrigeration cycle to be suddenly decreased, thereby making it possible to prevent components in a high-pressure line from being broken.

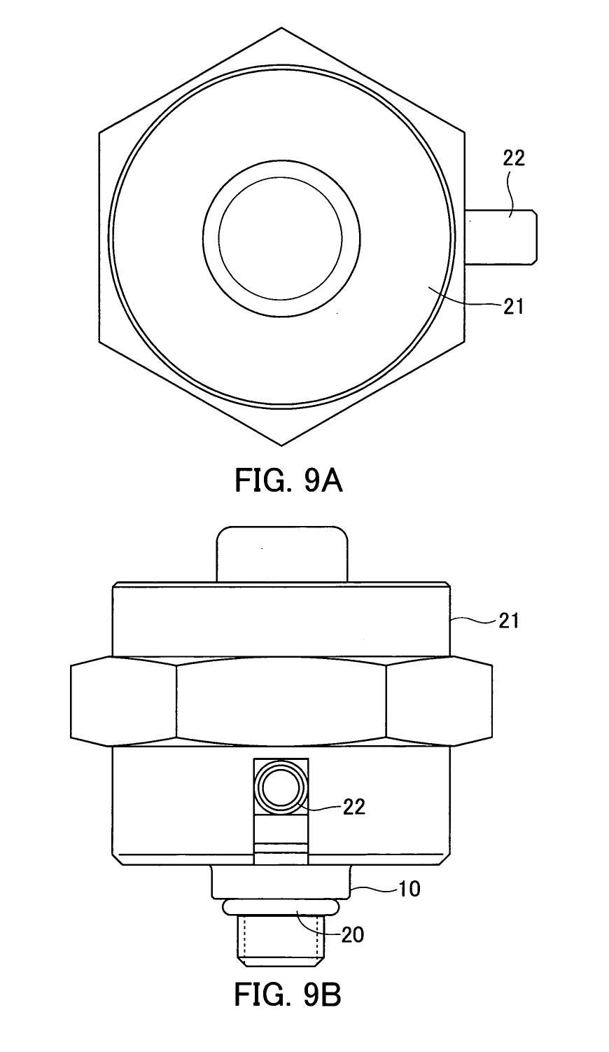

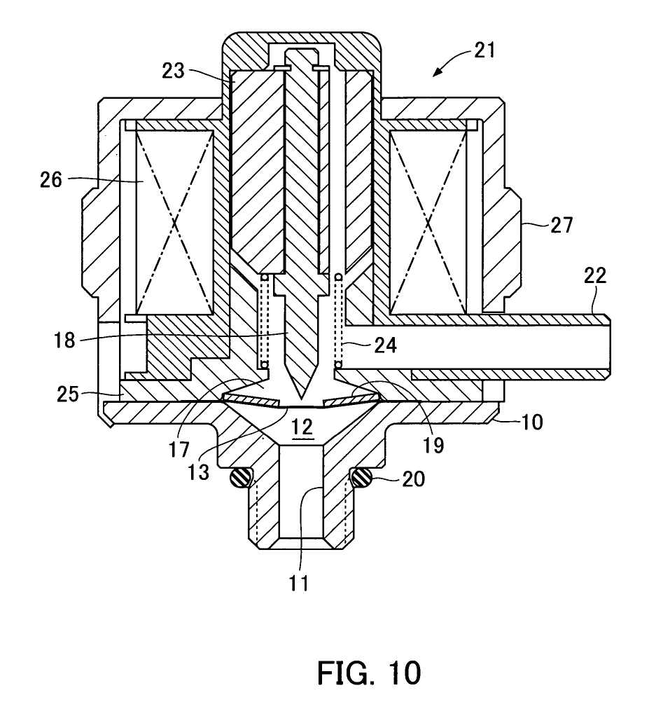

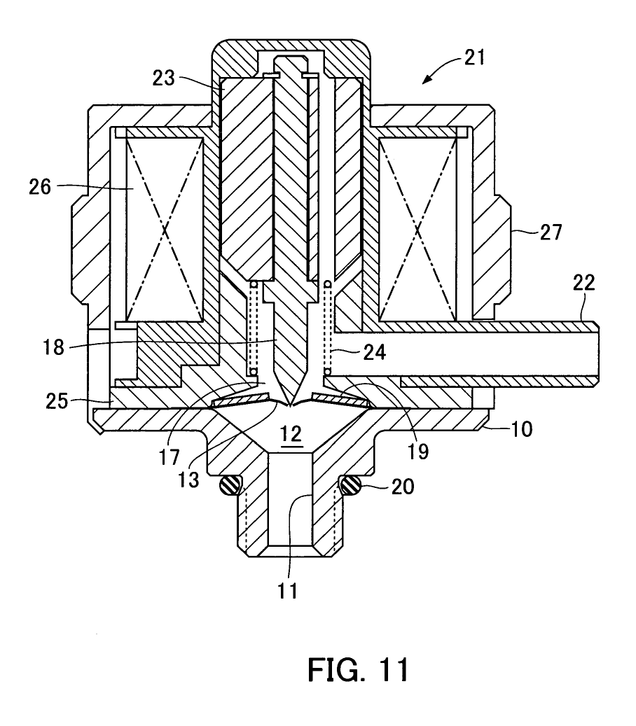

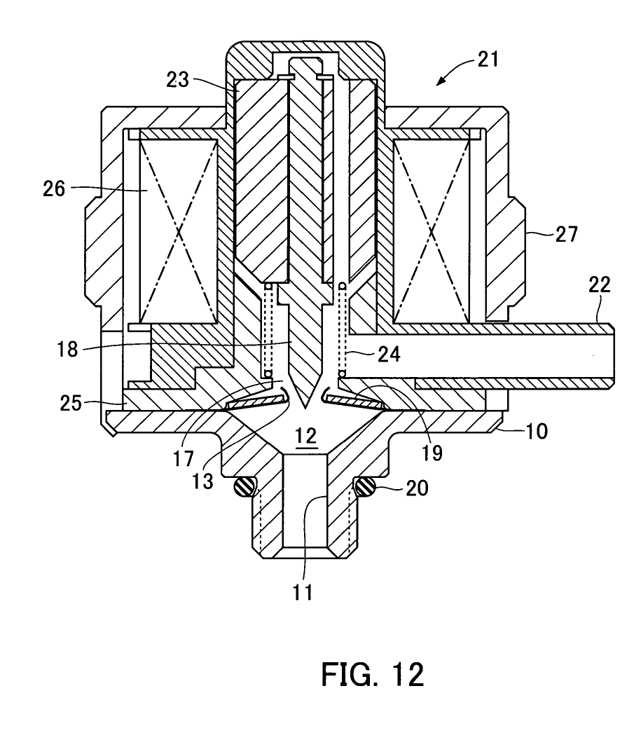

FIGS. 9A and 9B are diagrams showing general views of a refrigerant relief device according to a third embodiment of the present invention, wherein FIG. 9A is a plan view of the refrigerant relief device, and FIG. 9B is a right side view of the refrigerant relief device. FIG. 10 is a central cross-sectional view of the refrigerant relief device according to the third embodiment, in a normal pressure state. FIG. 11 is a central cross-sectional view of the refrigerant relief device according to the third embodiment, in a state in which abnormally high pressure is detected. FIG. 12 is a central cross-sectional view of the refrigerant relief device according to the third embodiment, in a state after the detection of abnormally high pressure. Component elements appearing in FIGS. 10 to 12, which have functions identical to or equivalent to those of the component elements appearing in FIGS. 1 to 3, are designated by identical reference numerals, and detailed description thereof is omitted.

The refrigerant relief device according to the third embodiment is distinguished from the refrigerant relief devices according to the first and second embodiments in that the structure of the thin film-breaking section is modified. More specifically, the refrigerant relief device according to the third embodiment is configured such that when refrigerant pressure in the refrigeration cycle has become an abnormally high pressure higher than a set pressure, the thin film-breaking section is operated by the pressure of the refrigerant, and further that even when pressure of refrigerant in the refrigeration cycle is not higher than the set pressure, the thin film-breaking section is caused to positively operate at a desired time point, thereby making it possible to release the refrigerant in the refrigeration cycle into the atmosphere.

Insofar as the appearance is concerned as shown in FIGS. 9A and 9B, the refrigerant relief device comprises the body 10 that forms a joint for connection to piping of the refrigeration cycle, and a solenoid 21 that is disposed above the body 10 and forms a thin film-breaking section. The solenoid 21 is provided with a conduit 22 configured to extend from a side thereof, for releasing refrigerant into the atmosphere. Further, the solenoid 21 is formed such that the outer periphery thereof has a shape of nut, so as to join the refrigerant relief device to the piping of the refrigeration cycle by screwing.

As shown in FIG. 10 which illustrates the internal construction of the solenoid 21, the piercing rod 18 is disposed in a manner movable forward and backward in a direction perpendicular to the plane of the metal thin film 13. The piercing rod 18 is rigidly fixed to a movable core 23 of the solenoid 21. The movable core 23 has a hole axially formed therethrough, and is urged by a spring 24 in a direction away from a fixed core 25. The fixed core 25 is disposed on the upper surface of the body 10, as viewed in FIG. 10, which has the metal thin film 13 welded thereto, and has a hole axially formed therethrough for arranging the piercing rod 18 and the spring 24 therein. The fixed core 25 has a lower end, as viewed in FIG. 10, which is integrally formed with a flange portion protruding radially outward for forming a magnetic circuit, and further provided with a horizontal hole for causing the open-to-atmosphere chamber 17 to communicate with the atmosphere. Between the fixed core 25 and the metal thin film 13 is disposed the belleville spring 19 for holding the metal thin film 13 receiving high pressure of refrigerant.

Disposed around the outer peripheries of the movable core 23 and the fixed core 25 is a coil 26. A bobbin for the coil 26 has a container for containing the movable core 23 and the fixed core 25, and the conduit 22 for releasing refrigerant into the atmosphere, the container and the conduit 22 being integrally formed with the bobbin e.g. by a resin. The refrigerant relief device is disposed e.g. in refrigerant piping in an engine room, and if the location where the refrigerant relief device is disposed is not suitable for releasing refrigerant, a hose may be connected to the conduit 22, to thereby guide refrigerant to a suitable location for releasing refrigerant. Outside the coil 26, a yoke 27 for forming the magnetic circuit is disposed, and a lower end of the yoke 27, as viewed in FIG. 10, is rigidly fixed to the body 10 by inwardly swaging to thereby rigidly fix the solenoid 21 to the body 10.

In the refrigerant relief device constructed as above, when refrigerant in the refrigeration cycle is at pressure within a normal range, the belleville spring 19 is placed in the state shown in FIG. 10 such that it holds the metal thin film 13 at a location away from the position of the tip of the piercing rod 18 against the pressure of refrigerant.

When the refrigerant pressure has become abnormal pressure higher than the set pressure, the belleville spring 19 is inverted in shape to be placed in the state shown in FIG. 11. As a result, since the central portion of the metal thin film 13 is displaced upward, as viewed in FIG. 11, to a location higher than the position of the tip of the piercing rod 18, the metal thin film 13 is pierced and broken by the piercing rod 18.

When the metal thin film 13 is broken, the abnormally high-pressure refrigerant is about to flow instantly from a hole formed in the film 13 by breakage thereof. Therefore, as shown in FIG. 11, the size of the hole formed in the metal thin film 13 is increased by the flowing refrigerant, and refrigerant in the refrigeration cycle is released into the atmosphere via the hole increased in size, the open-to-atmosphere chamber 17, and the conduit 22. This causes the pressure of the abnormally high-pressure refrigerant in the refrigeration cycle to be suddenly decreased, thereby making it possible to prevent components in a high-pressure line from being broken.

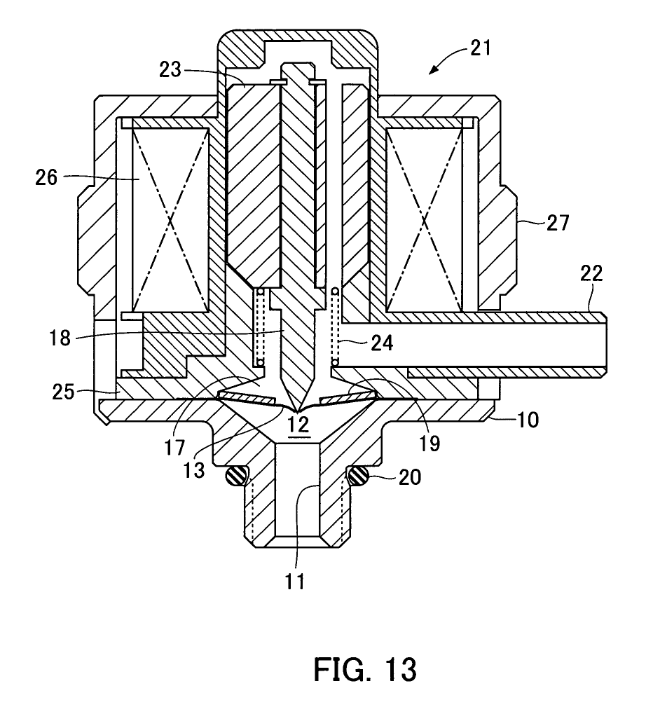

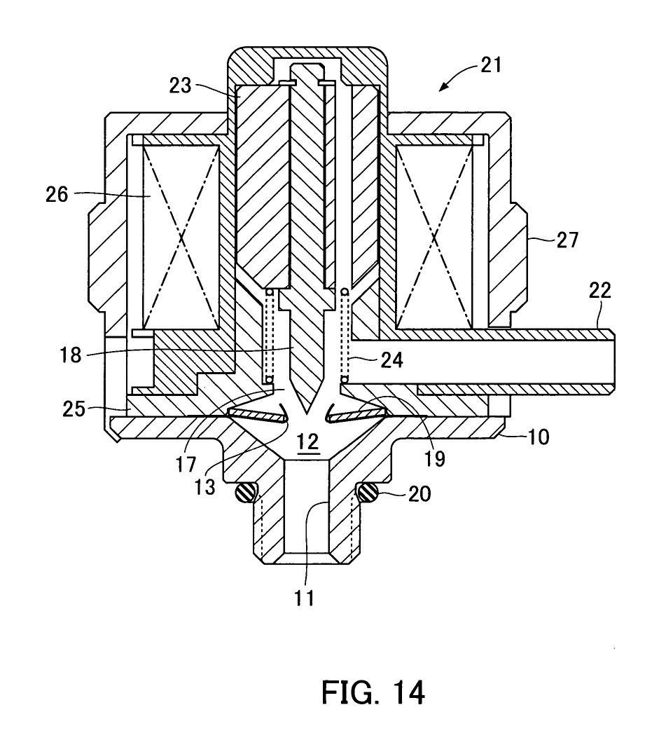

FIG. 13 is a central cross-sectional view of the refrigerant relief device according to the third embodiment, in a state during energization. FIG. 14 is a central cross-sectional view of the refrigerant relief device according to the third embodiment, in a state after the metal thin film is broken.

When refrigerant in the refrigeration cycle is at normal pressure within the normal range, for example, there is a case in which the refrigeration cycle is seriously damaged e.g. by a collision accident, causing a large amount of refrigerant to flow out into the vehicle compartment. At this time, if the refrigerant is harmful to occupants or inflammable, occupants confined in the vehicle compartment continue to be exposed to peril until they are rescued. In such a case, pulse current is supplied to the coil 26 e.g. for approximately 20 milliseconds, Then, the movable core 23 is attracted by the fixed core 25 against the urging force of the spring 24. This generates thrust for moving the piercing rod 18 fixed to the movable core 23 toward the metal thin film 13. When the movable core 23 is attracted to the fixed core 25, the tip of the piercing rod 18 formed at an acute angle breaks through the metal thin film 13, as shown in FIG. 13.

When pulse current ceases to be supplied to the coil 26, the movable core 23 is moved away from the fixed core 25 by the urging force of the spring 24, and the piercing rod 18 is pushed back by refrigerant blowing out from the broken metal thin film 13. After that, as shown in FIG. 14, the metal thin film 13 is ruptured by the force of the refrigerant blowing out from a hole formed by breaking the film 13 to increase the size of the hole, so that refrigerant in the refrigeration cycle is instantly released into the atmosphere via the conduit 22. This prevents a large amount of the refrigerant in the refrigeration cycle from emitting into the vehicle compartment, thereby making it possible to prevent occupants from being exposed to peril by emitted refrigerant.

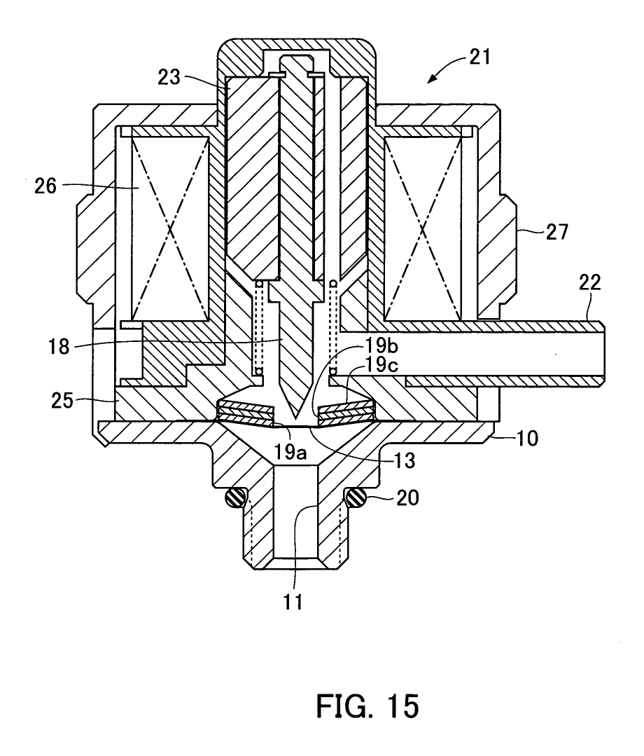

FIG. 15 is a central cross-sectional view of a refrigerant relief device according to a fourth embodiment of the present invention, in a normal pressure state. Component elements in FIG. 15 identical to those shown in FIGS. 6 to 9, and FIGS. 10 to 14 are designated by identical reference numerals, and detailed description thereof is omitted.

The refrigerant relief device according to the fourth embodiment is distinguished from the refrigerant relief device according to the third embodiment in that the thin film-holder is formed by three belleville springs 19a, 19b, and 19c overlaid upon each other. This make it possible to combine belleville springs 19a, 19b, and 19c which are different in load necessary for inverting the shape thereof, and therefore, it is possible to make a plurality of types of refrigerant relief devices which are different in set pressure. This refrigerant relief device is only different in set pressure from the refrigerant relief device according to the third embodiment but identical in operation thereto, and hence detailed description thereof is omitted.

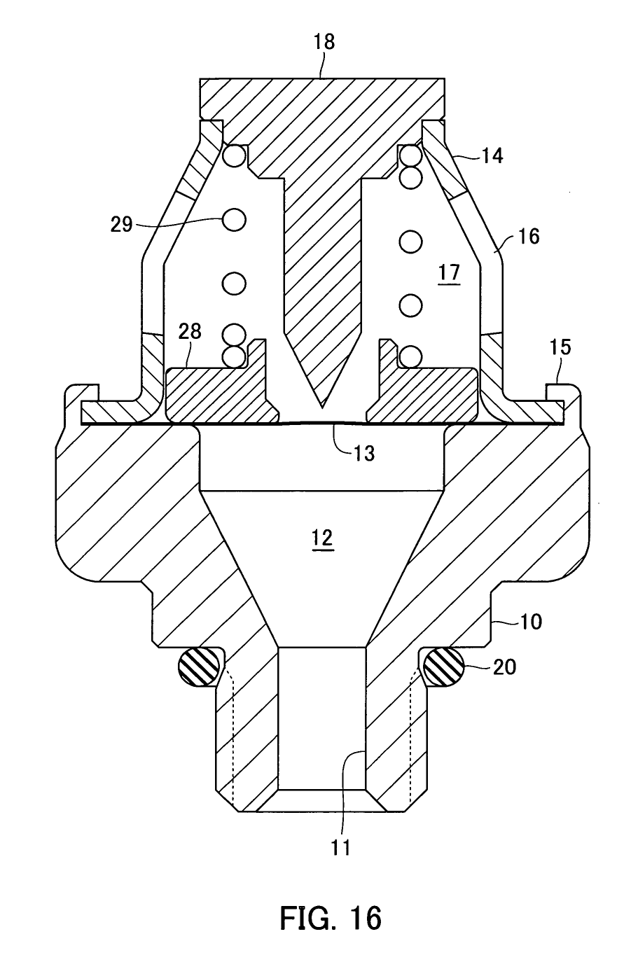

FIG. 16 is a central cross-sectional view of a refrigerant relief device according to a fifth embodiment of the present invention, in a state in which no pressure of refrigerant is applied thereto. It should be noted that component elements in FIG. 16 identical to those shown in FIGS. 1 to 3 are designated by identical reference numerals, and detailed description thereof is omitted.

The refrigerant relief device according to the fifth embodiment is distinguished from the refrigerant relief device according to the first embodiment in that the thin film-holder is differently configured. More specifically, the open-to-atmosphere chamber 17 surrounded by the housing 14 contains a disc 28 disposed in contact with the metal thin film 13 and a spring 29 disposed between the disc 28 and a root portion of the piercing rod 18, and the thin film-holder is formed by the disc 28 and the spring 29.

The disc 28 has an outer diameter which is large enough to place an outer periphery thereof on an upper surface of the body 10, as viewed in FIG. 16, via the metal thin film 13, and axially moves along the inner wall of the housing 14 in accordance with displacement of the metal thin film 13. The spring 29 has a spring force large enough to bear pressure of refrigerant in the refrigeration cycle.

The disc 28 has a through hole formed through the center thereof, and a pointed tip of the piercing rod 18 is disposed therein. The axial position of the piercing rod 18 is adjusted such that the tip of the piercing rod 18 is located at a position to which the metal thin film 13 is displaced when refrigerant pressure becomes equal to a set pressure at which the refrigerant relief device operates.

Therefore, as the pressure of refrigerant in the refrigeration cycle becomes higher, the metal thin film 13 is displaced more upward, as viewed in FIG. 16, against the urging force of the spring 29. When the pressure of refrigerant has reached the set pressure which should be detected as abnormally high pressure, the metal thin film 13 is brought into contact with the tip of the piercing rod 18. When this causes the metal thin film 13 to be damaged by the piercing rod 18, there occurs a brittle fracture in which the metal thin film 13 is cleaved from the damaged portion and fracture rapidly proceeds. As a result, refrigerant flows out from a broken portion of the metal thin film 13 to be released into the atmosphere via the open-to-atmosphere chamber 17 and the openings 16, so that the abnormally high refrigerant pressure in the refrigeration cycle is suddenly reduced, thereby making it possible to prevent components in the high-pressure line from being broken.

Since the refrigerant relief device according to the present invention is configured such that the first chamber communicating with the refrigeration cycle and the second chamber communicating with the atmosphere are isolated from each other by the thin film, it is possible to almost ideally seal between the first and second chambers, thereby making it possible to prevent leakage of the refrigerant completely. Furthermore, the thin film is configured to receive only the pressure of the refrigerant in the refrigeration cycle and be broken by the refrigerant pressure, and hence the refrigerant release device is reliable in operation, and simple in construction. Therefore, the present invention is advantageous in that it is possible to provide a refrigerant relief device which is high in reliability and manufactured at low costs.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A refrigerant relief device for releasing refrigerant filled in a refrigeration cycle for an automotive air conditioner into the atmosphere when pressure of the refrigerant in the refrigeration cycle has become abnormally high, comprising:
a thin film that is disposed in a manner gastightly isolating a first chamber connected to the refrigeration cycle for having the pressure of the refrigerant introduced therein and a second chamber communicating with the atmosphere from each other;
thin film-holding means disposed in the second chamber, for holding an amount of displacement of the thin film up to a predetermined value against the pressure of the refrigerant in the refrigeration cycle until the pressure of the refrigerant reaches a set pressure; and
a thin film-breaking section that is operable when the pressure of the refrigerant in the refrigeration cycle becomes higher than the set pressure to thereby cause the amount of displacement of the thin film to exceed the predetermined value, to break the thin film to thereby release the refrigerant in the refrigeration cycle into the atmosphere.

2. The refrigerant relief device according to claim 1, wherein the thin film-breaking section has a piercing rod that is formed such that a tip thereof opposed to the thin film has a pointed shape, and is fixed such that the tip is positioned closer to the first chamber than to a position to which the thin film is displaced when the pressure of the refrigerant has become higher than the set pressure.

3. The refrigerant relief device according to claim 1, wherein the thin film-holding means comprises at least one belleville spring in which axial positional relationship between a central portion thereof receiving the thin film and an outer periphery thereof whose axial motion is restricted is inverted, when the pressure of the refrigerant in the refrigeration cycle becomes higher than the set pressure.

4. The refrigerant relief device according to claim 1, wherein the thin film-breaking section comprises a piercing rod that is disposed in a manner movable forward and backward in a direction perpendicular to a plane of the thin film, and formed such that a tip thereof opposed to the thin film has a pointed shape, and a thrust-generating section that generates a thrust for moving the piercing rod toward the thin film.

5. The refrigerant relief device according to claim 4, wherein the thrust-generating section is a solenoid configured such that the piercing rod is rigidly fixed to a movable core urged in a direction away from a fixed core disposed on a side where the thin film exists.
